(19) United States
(12) Patent Application Publication
(10) Pub. No.: US 2024/0425380 A1
(43) Pub. Date: Dec. 26, 2024

(54) METHOD OF PRODUCING AMMONIA

(71) Applicant: Fortescue Future Industries Pty Ltd, East Perth (AU)

(72) Inventors: Vijay Pradhan, East Perth (AU); Kaushikkumar Gor, East Perth (AU); Ryan Worthington, East Perth (AU)

(21) Appl. No.: 18/705,912

(22) PCT Filed: Oct. 28, 2022
(86) PCT No.: PCT/AU22/51297

§ 371 Date: Apr. 29, 2024

(30) Foreign Application Priority Data
Oct. 29, 2021 (AU) 2021903465

(51) Int. Cl. C01C 1/04

(52) U.S. Cl. CPC C01C 1/0488

(57) ABSTRACT

A method of producing ammonia, including the steps of: operating a process for producing ammonia from hydrogen gas and nitrogen gas; and providing a liquid nitrogen storage; and injecting liquid nitrogen from the liquid nitrogen storage to the process for cooling of the process.

### FIELD OF THE INVENTION

The present invention relates to a method of producing and, more specifically but not exclusively, to a method of synthesizing green ammonia with a reduced energy requirement and improvement of product recovery.

### BACKGROUND OF THE INVENTION

The global production rate of ammonia has increased steadily since the 1950s and ammonia production has become one of the most important industries in the world. It is estimated that the annual production of ammonia is worth more than US$100 billion.

The applicant has identified that the demand for ammonia is already high for the production of fertilisers, and that the demand for ammonia may continue to increase significantly with the increasing use of ammonia as a CO₂ emission free fuel.

The applicant has identified that it would be desirable to provide technology for the production of green ammonia with optimised power usage and operability for renewable energy resources, improved reliability, reduced equipment count, improved production efficiency and/or improved safety.

Examples of the present invention seek to provide an improved method of producing ammonia which obviates or at least ameliorates one or more disadvantages of existing methods of producing ammonia.

### SUMMARY OF THE INVENTION

In a first aspect, the invention provides a method of producing ammonia, including the steps of: operating a process for producing ammonia from hydrogen gas and nitrogen gas; providing a liquid nitrogen storage; and using liquid nitrogen from the liquid nitrogen storage for cooling of the process.

In a second aspect, the invention provides a method of producing ammonia, including the steps of: operating a process for producing ammonia from hydrogen gas and nitrogen gas; injecting liquid nitrogen into a recycle loop of the process; and using the liquid nitrogen for cooling of the process.

In a third aspect, the invention provides a system for producing ammonia, comprising: a reactor for producing ammonia from a feed of hydrogen and nitrogen; a mixer fluidly connected downstream of the reactor for receiving the ammonia; and a liquid nitrogen storage configured to inject liquid nitrogen into the mixer for cooling and condensing of the ammonia into liquid ammonia; wherein the mixer forms part of a recycle loop, with unreacted hydrogen and nitrogen from the mixer being returned as feed to the reactor.

In a fourth aspect, the invention provides a method of producing ammonia, including the steps of: operating a process for producing ammonia from hydrogen and nitrogen; providing a liquid nitrogen storage; and using liquid nitrogen from the liquid nitrogen storage for cooling of the process as well as supplying nitrogen as a reactant for the process and energy recovery from process plants.

Disclosed herein is a method of producing ammonia, including the steps of: operating a process for producing ammonia from hydrogen gas and nitrogen gas; providing a liquid nitrogen storage; and using liquid nitrogen from the liquid nitrogen storage for cooling of the process.

Also disclosed herein is a method of producing ammonia, including the steps of operating a process for producing ammonia from hydrogen gas and nitrogen gas produced from vapourising liquid nitrogen in the reactor product stream; providing a liquid nitrogen storage; and pumping liquid nitrogen from the liquid nitrogen storage to provide cooling duty for the process and to supply the raw material for the synthesis reaction.

Preferably, the method includes the step of removing ammonia from the reactor outlet mixture to maintain ammonia production in the process.

Preferably liquid nitrogen will be pumped instead of compressing gaseous nitrogen along with hydrogen, this will reduce volumetric flowrate of synthesis gas compressor and electrical power requirement.

In a preferred form, the step of using liquid nitrogen includes injecting the liquid nitrogen into the synthesis loop in the synthesis reactor product line to facilitate cooling, condensing and separation of liquid ammonia.

Preferably, the step of removing ammonia through cooling with liquid nitrogen is used to reduce refrigeration duty and cooling duty in the cooling step. A colder temperature due to the addition of liquid nitrogen will condense more ammonia compared with conventional processing chiller temperatures. The recycle loop flowrate will be reduced due to improved separation of ammonia.

Preferably, the injection of liquid nitrogen will reduce the duty and mass flow in the synthesis gas compressor and there will only be a hydrogen compression step in the feed to the reactor.

Preferably, the method includes the step of using the liquid nitrogen storage as a storage of feedstock. More preferably, the method includes the step of generating liquid nitrogen at times of high electrical power availability to build up feed storage that can be fed into the process at times of low power availability. The liquid nitrogen can be generated constantly and stored for use when required.

Preferably, the method includes the use of hydrogen storage to provide buffer supply of hydrogen for periods of low power availability. More preferably, the method includes the step of generating gaseous hydrogen at times of high power availability to build up feed storage that can be fed into the process at times of low power availability.

Preferably, the method includes the step of using the excess production of liquid nitrogen which can be stored as a storage of cold material. More preferably, the method includes the step of using liquid nitrogen from the storage to generate electricity. Even more preferably, the step of using liquid nitrogen to generate electricity by vapourising the liquid nitrogen and then superheating the vapour before generating power through a mechanical turbine coupled to an electrical generator in a Brayton cycle. More preferably, the heat of compression in the production of liquid nitrogen can be stored in thermal storage material which can be used to vapourise and heat the nitrogen in the generation step, thereby improving the overall efficiency.

In a preferred form, the stored cold mass of liquid nitrogen is used for cooling of electrolysis heat rejection and/or other process cooling requirements.

Preferably, the method includes the step of pumping liquid nitrogen to remove the requirement to compress nitrogen vapour to high-pressure in the synthesis loop which reduce synthesis loop compressor energy requirements.

In accordance with another aspect of the present invention, there is provided a method of producing ammonia, including the steps of operating a process for producing ammonia from hydrogen gas and nitrogen gas; injecting liquid nitrogen into a recycle loop of the process; and using the liquid nitrogen for cooling of the process.

Preferably, the method further includes the step of providing a storage of liquid nitrogen, wherein the step of injecting liquid nitrogen injects liquid nitrogen from the storage into the recycle loop.

### BRIEF DESCRIPTION OF THE DRAWINGS

The invention is further described by way of non-limiting example only with reference to the accompanying drawings, in which:

FIG. 1 shows a diagrammatic process flow view of a method in accordance with an example of the present invention;

FIG. 2 shows a block flow diagram of a method in accordance with an example of the present invention.

FIG. 3 shows a block flow diagram of an existing typical green ammonia process adapted from existing synthesis technologies.

### DETAILED DESCRIPTION

Ammonia synthesis plants usually have a section in the plant where hydrocarbon feed is converted to ammonia synthesis gas which is a mixture of hydrogen and nitrogen in an approximate molar ratio of 3:1. Hydrogen is combined with nitrogen in a catalytic reaction to produce ammonia via the Haber Bosch process:

3H₂+N₂→2NH₃

The reaction is reversible and exothermic in the forward direction. The reversible reaction follows Le Chatelier's principle whereby changes to a system will cause the opposite change in the reverse direction. In order to sustain production of ammonia in the forward direction the product needs to be removed from the reaction mixture.

The conventional ammonia production process utilises hydrocarbon feedstock to provide the source of hydrogen via steam methane reforming (SMR). Nitrogen for the process is introduced in the reforming section as air which is used to partially combust and reform the remaining hydrocarbons to CO₂ and H₂ with the nitrogen in the air being unreacted. Subsequent processing to remove oxygen containing species such as H₂O, O₂, CO₂ and CO in order to prevent the ammonia synthesis catalyst from being poisoned in the ammonia converter.

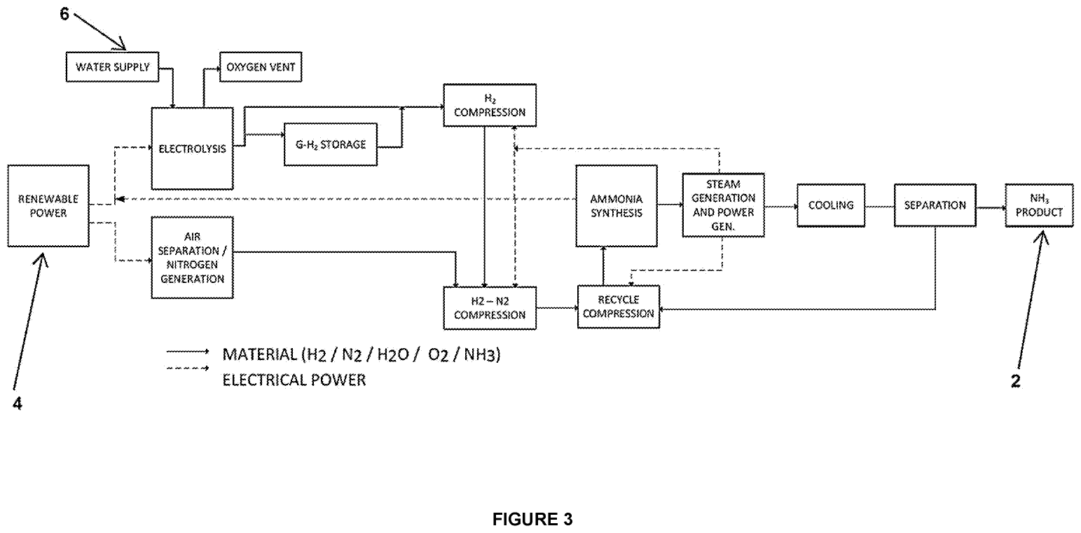

Alternative methods for the production of ammonia involve the splitting of water into H₂ and O₂ via electrolysis with electrical power supplied from renewable power resources. In order to complete the synthesis of ammonia in this process nitrogen is added to the hydrogen as a pure stream from an air separation unit (see the block flow diagram in FIG. 3). Publication U.S. Pat. No. 20,110,297886A1 discloses an example of an existing process for producing ammonia and urea.

A typical air separation unit will compress air in multiple stages with heat removal at each stage, which will then be sent to an air separation unit where the air will be cooled and reduced in pressure through an isentropic mechanical turbine to reduce the temperature. The cool fluid is used to cool the feed air which will drop the outlet temperature of the turbine further. The temperature drops to the point where liquid nitrogen and oxygen is generated and the vapour and liquid can be distilled to produce high purity liquid nitrogen and nitrogen vapour.

Using renewable energy for the supply of power for electrolysis and the operation of the ammonia synthesis process will produce green ammonia.

Green ammonia processes from technology licensors typically use the synthesis section of the existing process. The existing processes are designed to operate at a constant nameplate capacity for the optimal production efficiency and have limitations on the amount of production turndown limits and production rate increases in order to sustain the optimum conditions for the ammonia conversion in the reactor. The synthesis reaction is exothermic and the conditions are held constant at a consistent molar ratio of hydrogen and nitrogen, pressure and temperature at the inlet of the reactor.

Upon leaving the reactor the temperature is increased due to the heat generated in the conversion reaction. This heat can be recovered to generate steam, which can be used to generate electrical power. Through a single pass of the reactor approximately 20% of the feed products are converted to ammonia on a molar basis. On leaving the reactor the ammonia, nitrogen and hydrogen vapour mixture is subsequently cooled through multiple exchangers and the ammonia is condensed out of the mixture and separated from the unreacted hydrogen and nitrogen. The cooling is achieved with a mixture of cooling utility, heat recovery with the recycle loop and external mechanical refrigeration circuit which requires compression and condensing of the refrigerant requiring power and cooling duty.

The unreacted hydrogen, nitrogen and residual ammonia vapour is recycled back to the reactor and the cold temperature can be used to cool the reactor product stream and preheat the recycle stream to the required reactor inlet temperature.

The challenges with green ammonia production that uses feed stocks and power that is derived from renewable energy is that there is a large potential for intermittency and long periods on a diurnal cycle without power, for example at night for a solar photovoltaic resource. Hydrogen feed would also be interrupted in this case also. Without power and feed the exothermic synthesis reaction cannot be sustained. Due to the intermittent supply of power for production of green ammonia, energy storage and feed storage is required to sustain production of ammonia.

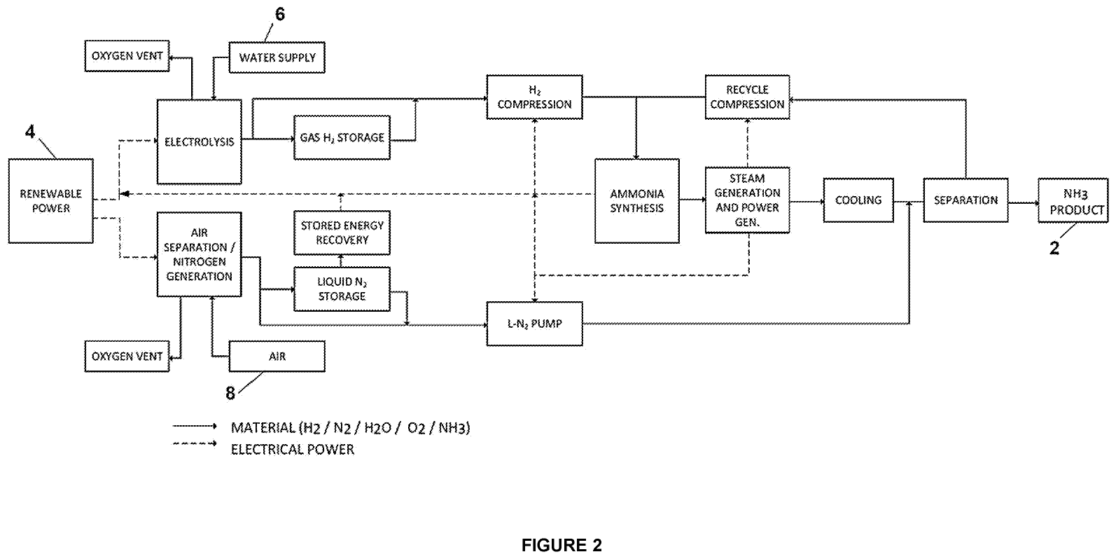

As can be seen in FIG. 2, in accordance with an example of the present invention, there is depicted as a block flow diagram a method of producing ammonia, 2, from renewable energy, 4, water, 6, and air, 8. This is in contrast to the existing method of producing ammonia shown in FIG. 3, in which like features are depicted with like reference numerals.

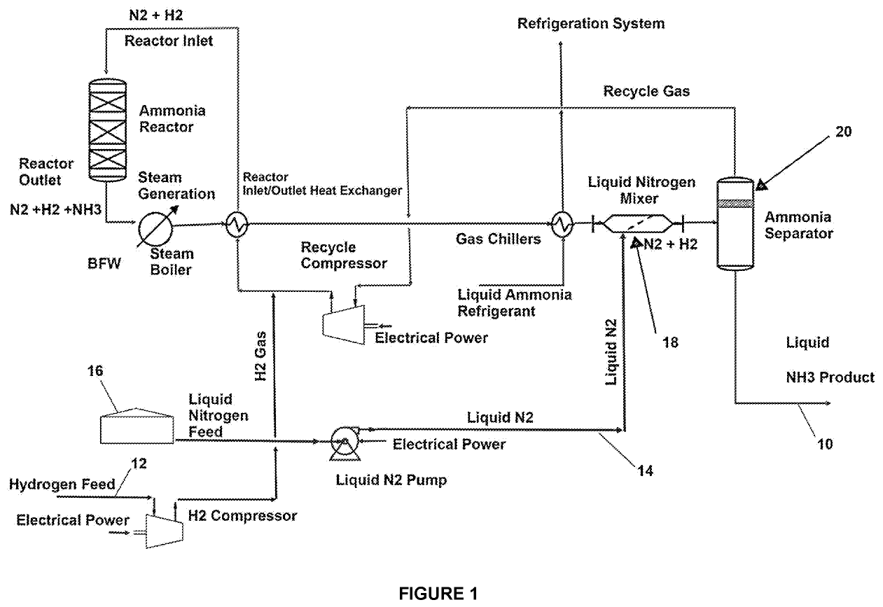

With reference to FIG. 1, there is depicted diagrammatically a method of producing ammonia 10 in accordance with an example of the present invention. The method includes the steps of operating a process for producing ammonia 10 from hydrogen gas 12, providing a liquid nitrogen storage 16, and using liquid nitrogen from the liquid nitrogen storage 16 for cooling of the process and the addition of the nitrogen feed, 14.

The method may include the step of removing ammonia 10 to avoid chemical equilibrium so as to maintain operation of the process in the forward direction of the ammonia synthesis reaction when recycling to the inlet of the reactor. The step of using liquid nitrogen may include injecting the liquid nitrogen into a synthesis reactor product line to facilitate separation of liquid ammonia 10. The addition of liquid nitrogen will be in the correct ratio to the hydrogen feed for the optimal ratio for ammonia synthesis.

The pressure for the synthesis of ammonia will be provided with the constant addition of hydrogen gas from the hydrogen gas compressor. The liquid nitrogen pump will have sufficient discharge pressure to inject liquid nitrogen in the right proportion to optimise the ratio of nitrogen and hydrogen at the inlet of the reactor.

The step of removing ammonia 10 via condensing with the addition of the cold liquid nitrogen may be used to reduce cooling and mechanical refrigeration requirements, to implement a smaller synthesis compressor and/or to minimise recycling of ammonia product. The use of liquid nitrogen as cooling duty will reduce the refrigeration circuit compressor power requirements as the rate of refrigerant circulation will be reduced. The method may include the step of pumping liquid nitrogen to high-pressure to reduce synthesis compressor energy requirements.

The cooling duty from the liquid nitrogen will be achieved with the mixing of liquid nitrogen into the gas stream using a specific mixing device (see liquid nitrogen mixer 18 in FIG. 1) to maximise the contact between the liquid nitrogen and gas stream and ensure all of the liquid nitrogen is vapourised prior to the separator 20. As the temperature of the gas stream is higher in temperature than the liquid nitrogen, the heat will transfer to the liquid nitrogen and vapourise the liquid nitrogen. The vapourisation of the liquid nitrogen by direct contact of the vapour stream removes more heat than sensible heat transfer with an external fluid in a heat exchanger, whilst providing the required nitrogen make up flow to the synthesis loop. As the temperature of the gas stream reduces this will cause ammonia to condense into the liquid phase along with trace amounts of nitrogen and hydrogen which are in equilibrium as the specific temperature and pressure. The condensed liquid is separated in a separator vessel where the high purity ammonia liquid is produced. The separated vapour is recycled through the synthesis loop to the ammonia conversion reactor. The reaction will be exothermic and generate heat and the reaction product will contain a vapour mixture of nitrogen, hydrogen and ammonia. The temperature and enthalpy of the reactor product will be sufficient to generate superheated steam that can be used to drive mechanical turbines for power generation. The generated power will offset the electrical power that is provided by the renewable energy to power the electrical equipment in synthesis process and operate the equipment to generate the liquid nitrogen.

It is proposed that during times of high power availability there will be an overproduction of feed material that can be stored for synthesis during low power periods. The air separation unit, renewable power supply and electrolysis are oversized in relation to the throughput capacity so that storage of hydrogen and liquid nitrogen can be filled.

During times of low power operation the power consumption of the synthesis process will be lower as the air separation unit will not be producing liquid nitrogen so the requirement for energy storage for continuous operation is reduced. Lower power production is achieved with the addition of nitrogen feed via a pump which uses less power compared with a gaseous compressor and the addition of hydrogen from compression to the synthesis gas loop will use less power than a combined synthesis gas compressor.

During periods of low renewable energy the reaction can still occur if there is enough power to add the feed at the correct rate and pressure. The generated electricity from the steam generation will continue to occur.

Due to the configuration of the design and how the feed material is added it will be possible to reduce the flow of nitrogen and hydrogen to the synthesis loop. Hydrogen compression will be via a reciprocating compressor which can be flow controlled to low rates without excessive power usage and recycle flow that would be required with a centrifugal synthesis gas compressor. Pumping liquid nitrogen will also be able to be controlled at specific low rates. The recycle compressor and flow rate will be limited in turn down as it will likely be a centrifugal compressor, however the recycle flowrate can be maintained in the synthesis with a low power demand relative to the hydrogen gas compression and air separation power usage.

Higher flexibility of the process will allow the storage requirements for liquid nitrogen, hydrogen plus stored energy to be lower as power usage and production can be minimised during times of low power.

The over production of liquid nitrogen storage 16 may be used as a storage of energy when there is excess available. This stored energy can be used in times of low power to provide power for synthesis. In particular, the method may include the step of using liquid nitrogen from the storage 16 to generate electricity. In one form, the step of using liquid nitrogen to generate electricity uses the Brayton cycle.

The cold liquid nitrogen may be integrated into the cooling circuit for electrolysis heat rejection and/or for other process cooling requirements.

Specifically, the liquid nitrogen may be injected from the storage 16 into a recycle loop of the process for cooling of the process.

### BENEFITS OF THE INVENTION

This process is designed to be used with intermittent renewable energy whereby liquid nitrogen and hydrogen feed can be produced in excess when the higher energy demand for electrolysis and air separation is available and the raw material can be stored.
(1) Liquid nitrogen is used as an stored process raw material feed stream, energy storage and cold storage medium, this will improve ammonia plant operation.
(2) The store and generation of liquid nitrogen can be integrated to be used to generate cooling for the synthesis loop cooling, ammonia product cooling and condensing, and other process cooling requirements including electrolysis of water for hydrogen feedstock production.
(3) Excess liquid nitrogen can be generated to be used as a storage of energy. The liquid nitrogen will be pumped, heated, vaporised and expanded through a mechanical device to generate electricity via a Brayton cycle. This may be similar to existing liquid air energy storage schemes, however the integration of the cooling duty for the electrolysis of water and feed stream (nitrogen) manufacture and mixing into the synthesis loop of the process is inventive in this application.
(4) Pumping of liquid nitrogen to high pressure requires less energy compared to energy required to compress mixture of nitrogen gas and hydrogen gas in the synthesis compressor. Implementation of this aspect has the potential to save at least 20% of energy used by a synthesis compressor.
(5) Examples of the invention use refrigeration capacity of liquid nitrogen that results in reduction of existing ammonia refrigeration loops. Example may reduce external refrigeration requirement by more than 20%.
(6) Injection of the liquid nitrogen may improve ammonia separation and production capacity. i.e. more liquid ammonia will be separated that will make the synthesis reaction more efficient.
(7) Overall energy efficiency of the ammonia synthesis loop will improve.
(8) Improve safety, reliability and capital expenditure by reducing quantity of equipment and stored refrigerant quantity in the process plant.
(9) This may assist reduction in energy storage requirement due to higher allowable variability in the process.

A potential benefit is the lower power consumption during low power availability periods by using stored liquid nitrogen for cooling. Examples of the present invention may help operate the plant at higher load during night time, or low/no renewable energy generation periods.

The exothermic reaction process of ammonia synthesis will generate steam and electrical power which will be sufficient to provide some of the power for the operation of the ammonia synthesis process where the main power users are the hydrogen compression and synthesis loop recycle compression. The liquid nitrogen injection power is low compared to the compression power usage and the liquid nitrogen generation power requirement will be reduced during low renewable energy power periods, or can be averaged out to supply feed nitrogen or to build up storage. The liquid nitrogen injection reduces the mechanical refrigeration requirements that are currently used to condense ammonia from the product stream—this also reduces electrical power consumption.

Accordingly, as will be appreciated from the above, examples of the present invention may provide a process to make green ammonia production more energy efficient, reliable, safe and steady by injecting liquid nitrogen into a recycle loop. The applicant has identified that injecting liquid nitrogen into the synthesis reactor product line may be used advantageously so that liquid ammonia can be separated efficiently reducing the duty requirements of refrigeration, using a smaller synthesis compressor and minimising recycling of ammonia product.

Conventionally, hydrogen is produced from fossil fuels in the reforming section which produces waste energy that is used to power the plant. The applicant has identified that the green ammonia pathway uses hydrogen generated from renewable electricity which is usually intermittent and the electrolysis of hydrogen does not have a the same high grade waste heat and heat of reaction to recover and power the process compared with steam methane reforming. Moreover, the ammonia reaction is equilibrium limited—more than 20% ammonia conversion may reverse the reaction therefore ammonia produced in the ammonia reactor is separated by cooling, condensing and separating the ammonia. Cooling and condensing is achieved using an ammonia refrigeration system that is powered by waste heat generation.

The applicant has identified that existing patent publications involving liquid nitrogen are to provide a liquid nitrogen wash in conventional ammonia plants to remove impurities upstream of the synthesis section. The applicant does not have this situation or requirement in a green ammonia plant.

Advantageously, the applicant has identified the possibility of improved efficiency by using liquid nitrogen which was previously counter-intuitive for a number of reasons. More specifically, previously, excessive waste heat from reforming was more efficiently used to generate steam and drive compression equipment in the refrigeration system otherwise it would be wasted. There was previously no need for liquid nitrogen as nitrogen is obtained from the air in conventional process as oxygen is needed in the reforming step. The currently technology providers' green processes without steam methane reforming replicate the synthesis sections of their proprietary technologies with independent hydrogen and nitrogen make-up as gases controlled to the optimum stoichiometric ratio.

The present invention was conceptualised when attempting to address issues related to energy storage and intermittency. The applicant was prompted by the following factors:
1. Conventional ammonia production uses the excess waste heat to drive the refrigeration compressor in order to generate cold liquid to exchange heat with in order to cool and condense ammonia. This energy would otherwise be used to make steam for export or wasted as rejected heat. The green process has less energy generation in the process due to the missing reforming section that produces most of the waste heat (60%).
2. Conventional ammonia production uses nitrogen from the air through an air compressor, the oxygen in the air issued in the combustion system in the secondary reformer to make the process more efficient. Green ammonia does not require oxygen and uses pure nitrogen from a liquified nitrogen cryogenic air separation unit (ASU). The liquid nitrogen has to be vaporised to be used in the ammonia synthesis conversion loop.
3. The ammonia condensing is partially achieved in the green ammonia by liquid nitrogen instead of a dedicated refrigeration system. The overall energy of the cooling and condensation system is reduced using this method.
4. The storage of liquid nitrogen reduces the energy requirements at night as the associated duty for cooling is stored as cold liquid when the renewable energy is unavailable (or lower) and has the potential to enable continuous operation at night with reduced power consumption, and therefore requiring less energy storage compared to a conventional ammonia synthesis process which requires electrical power to drive the refrigerant compressor in order to provide cooling
5. The ammonia produced is (can be) tailored for use in fuel applications as well as fertiliser.

### Inventive Elements

(i). Liquid Nitrogen is Injected into Synthesis Reactor Product Stream

At present, all the ammonia technologies compress mixture of hydrogen gas (75% v) and nitrogen gas (25% v) from @ 10 to 12 bar-a to 130 to 200 bar-a. The stoichiometric gaseous mixture is termed as synthesis gas and the compressor is termed a synthesis gas compressor. Compressing gaseous mixture to ammonia reactor pressure is an energy intensive process. Examples of the present invention may pump liquid nitrogen at 12 bar-a to an elevated pressure of 130 bar-a to 200 bar-a into the synthesis reactor product line. Pumping of liquid nitrogen not only reduces volumetric flowrate of the synthesis compressor but may also save on a compressor electrical power requirement.

### (ii). Reduction of Ammonia Refrigeration Requirement and Duty for Liquification Condensing of Ammonia Gas

At present, the synthesis reactor's product is cooled by a series of heat exchangers that exchange heat in the reaction synthesis loop, dedicated cooling utilities, and mechanical refrigeration to reduce the temperature lower for the condensing of ammonia. Examples of the present invention reduce external cooling requirements for ammonia gas liquification. Evaporating subcooled nitrogen liquid in the synthesis reactor product provides major refrigeration requirement to produce liquid ammonia.

Injecting subcooled liquid nitrogen into the synthesis gas reactor product gas reduces requirement of large dedicated mechanical refrigeration facility while reducing power requirement of synthesis gas compressor.

As proposed by examples of this invention, the direct injection of subcooled liquid nitrogen separates more liquid ammonia from the reactor product due to a lower separation temperature compared with other processes.

(iii). Multiple Use of Liquid Nitrogen

Liquid nitrogen has the benefit of acting as storage that can be deployed into the process as cooling and feed. The store of cold mass can also be used to store energy which can be released when pumped, vaporised and then reduced in pressure through a mechanical turbine coupled to an electrical generator in a Brayton cycle.

The store of excess cold can also be utilised in assisting the cooling requirements of the of the water electrolysis process.

The mass balance and reaction of ammonia is unchanged—it is only the method of cooling and condensing of ammonia at the final separation step using direct cooling with liquid nitrogen rather than external mechanical refrigeration.

### Example

An example green plant considers the use of liquid air and/or liquid nitrogen for recovering all level energies for power generation. The example plant advantageously removes utilities e.g. cooling water, steam, steam turbine that are typically associated with ammonia plants. This will improve green ammonia plant energy efficiency and reliability.

The example green plant involves directly injecting liquid nitrogen into a product stream of the ammonia reactor. The Liquid nitrogen is sprayed into a pipeline of a recycle unit upstream of a liquid nitrogen separator in stoichiometric proportion of hydrogen fed into reactor will. The (liquid) ammonia separator, which separates nitrogen gas from the liquid ammonia. The (recycled) nitrogen gas is then be used as a feed stream for the ammonia reactor. The example green plant does not require a synthesis gas compressor or any machinery handling synthesis gas. This improves energy efficiency and ammonia recovery.

The gas hydrogen is injected into a feed stream of the ammonia reactor downstream of a recycle compressor. The example green plant is applicable irrespective of the method of producing hydrogen and/or operating pressure of ammonia in the synthesis section. Further, the production of ammonia by the synthesis of hydrogen and nitrogen is conducted irrespective of the operating pressure of hydrogen or the source of hydrogen (i.e. by electrolysis or other means). If required, hydrogen can be compressed using hydrogen compressor. Heat of compression is used to optimise heating requirement of the reactant gasdes. Accordingly, the process of the green plant can be implemented irrespective of downstream or upstream products or processes.

The direct injection (of liquid nitrogen) fulfils several objectives e.g. reduction of number of machineries, 100% capacity utilisation of air separation unit that results into smaller size air separation unit, smaller size of refrigeration unit, smaller size of recycle compressor and reactor feed compressor and improved separation of ammonia. The 100% utilisation of air separation unit capacity for variable power supply size of air separation unit is reduced below 50% that of conventional ammonia plants that are reliant on using gas nitrogen as raw material. It improves ammonia separation, efficient use of power and optimisation of Air Separation Unit.

The example green plant uses renewable energy to power the reactor, specifically solar and wind power. Feed material hydrogen is produced by electrolysis of water. Feed material nitrogen is produced by air separation in the separator. Large scale air separation is typically a cryogenic process. The green plant reduces air separation unit capacity to less than 50% that of conventional plant. Whilst the reduction in air separation unit capacity (because of the direct injection) is particularly applicable to ammonia plants using intermittent source of energy, it can be used for all type of ammonia plants without any constraint.

Existing ammonia plants are not as energy efficient as the green plant. For example, nitric acid complexes with upstream ammonia plants recover low level heat using pressurised oxygen and air, expand them and mix with ammonia for combustion to form nitrous oxide. Such plants do not reduce the capacity of air separation unit used during ammonia production, instead focusing on increasing combustion temperature of ammonia by supplying oxygen enriched air for combustion.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

### Listing of reference numerals

2 NH₃ product
4 Renewable power
6 Water supply
8 Air
10 Ammonia
12 Hydrogen gas
14 Nitrogen feed
16 Liquid nitrogen storage
18 Liquid nitrogen mixer
20 Separator

1. A method of producing ammonia, including the steps of:
operating a process for producing ammonia from hydrogen gas and nitrogen gas;
providing a liquid nitrogen storage; and
using liquid nitrogen from the liquid nitrogen storage for cooling of the process.

2. A method as claimed in claim 1, including the step of removing ammonia to avoid equilibrium to maintain operation of the process.

3. A method of producing ammonia as claimed in claim 1 or claim 2, wherein ammonia from the process is fed into a mixer, and the step of using liquid nitrogen includes injecting the liquid nitrogen into the mixer to directly contact the ammonia and facilitate cooling and/or condensing of liquid ammonia.

4. A method of producing ammonia as claimed in any one of claims 1 to 3, wherein the step of cooling with liquid nitrogen is used to reduce refrigeration duty of a refrigeration system, to implement a smaller synthesis compressor and/or to remove the synthesis compressor and/or to minimise recycling of ammonia product.

5. A method as claimed in any one of the preceding claims, including the step of providing a renewable power supply for powering the process.

6. A method of producing ammonia as claimed in any one of claims 1 to 5, wherein the method includes the step of using the liquid nitrogen storage as a store of energy.

7. A method of producing ammonia as claimed in claim 5, including the step of using liquid nitrogen from the storage to generate electricity for powering the process.

8. A method as claimed in claim 7 when dependent from claim 5, wherein the liquid nitrogen from the storage is used to power the process during periods of low power production by the renewable power supply.

9. A method of producing ammonia as claimed in claim 7 or claim 8, wherein the step of using liquid nitrogen to generate electricity uses the Brayton cycle.

10. A method as claimed in any one of the preceding claims, wherein steam generated by the process is used to produce electricity.

11. A method as claimed in claim 10 when dependent from claim 5, wherein electricity generated by the process at least partly offsets intermittency of electricity generation by the renewable power supply.

12. A method of producing ammonia as claimed in any one of claims 1 to 11, wherein the liquid nitrogen is used for cooling of electrolysis heat rejection and/or other process cooling requirements.

13. A method of producing ammonia as claimed in any one of claims 1 to 12, including the step of pumping liquid nitrogen to an elevated pressure to reduce energy requirements of the process.

14. A method of producing ammonia as claimed in claim 13, wherein said elevated pressure is within the range of 130 bar-a to 200 bar-a.

15. A method as claimed in any one of claims 1-14, including the step of separating unreacted hydrogen and nitrogen from the ammonia, and recycling the unreacted hydrogen and nitrogen as feed for the process.

16. A method of producing ammonia, including the steps of:
operating a process for producing ammonia from hydrogen gas and nitrogen gas;
injecting liquid nitrogen into a recycle loop of the process; and
using the liquid nitrogen for cooling of the process.

17. A method of producing ammonia as claimed in claim 16, further including the step of providing a storage of liquid nitrogen, wherein the step of injecting liquid nitrogen injects liquid nitrogen from the storage into the recycle loop.

18. A system for producing ammonia, comprising:
a reactor for producing ammonia from a feed of hydrogen and nitrogen;
a mixer fluidly connected downstream of the reactor for receiving the ammonia; and
a liquid nitrogen storage configured to inject liquid nitrogen into the mixer for cooling and condensing of the ammonia into liquid ammonia;
wherein the mixer forms part of a recycle loop, with unreacted hydrogen and nitrogen from the mixer being returned as feed to the reactor.

19. A system for producing ammonia as claimed in claim 18, further comprising:
a renewable power source configured to provide electricity to power the reactor.

20. A system for producing ammonia as claimed in claim 18 or claim 19, further comprising:
a separator arranged downstream of the mixer and forming part of the recycle loop, with unreacted hydrogen and nitrogen gas being separated from the liquid ammonia to produce a high purity liquid ammonia.

21. A method of producing ammonia, including the steps of:
operating a process for producing ammonia from hydrogen and nitrogen;
providing a liquid nitrogen storage; and
using liquid nitrogen from the liquid nitrogen storage for cooling of the process as well as supplying nitrogen as a reactant for the process and energy recovery from process plants

22. A method of producing ammonia as claimed in claim 21, including the step of using liquid nitrogen from the storage to recover process heat energy and to generate electricity for powering the process.

23. A method of producing ammonia as claimed in claim 21 or claim 22, wherein ammonia from the process is fed into a mixer, and the step of using liquid nitrogen includes injecting the liquid nitrogen into the mixer to directly contact the ammonia product of the process and to facilitate cooling and/or condensing of the gaseous ammonia product to liquid ammonia product.

24. A method of producing ammonia as claimed in claim 23, wherein heat from the ammonia product within the mixer is transferred to the liquid nitrogen that is injected into the mixer to vapourise the liquid nitrogen.

25. A method of producing ammonia as claimed in claim 24, wherein the vapourised liquid nitrogen is recycled as a feed to the process as nitrogen gas.
